(19) United States
(12) Patent Application Publication
(10) Pub. No.: US 2026/0361642 A1
(43) Pub. Date: Nov. 12, 2026

(54) Optimized MPLS Label Allocation for BGP L3VPN Route Reflectors

(71) Applicant: Ciena Corporation, Hanover, MD (US)

(72) Inventors: Param Preet Dhillon, Gurgaon (IN); Piyush Sharma, Gurgaon (IN); Varun Munjal, Gurgaon (IN); Anil Dharmshaktu, New Delhi (IN)

(73) Assignee: Ciena Corporation, Hanover, MD (US)

(21) Appl. No.: 19/202,051

(22) Filed: May 8, 2025

(30) Foreign Application Priority Data
Mar. 26, 2025 (IN) 202541028342

(51) Int. Cl. H04L 45/28; H04L 45/02; H04L 45/50

(52) U.S. Cl. CPC H04L 45/28; H04L 45/04; H04L 45/50

(57) ABSTRACT

In large-scale BGP L3VPN deployments, inline route reflectors (RRs) often exhaust their MPLS label capacity when each prefix requires a unique label. This disclosure introduces a per-flow label allocation technique that groups prefixes sharing the same forwarding attributes (e.g., out label, next-hop, backup label, backup next hop) under a single label. By consolidating routes with identical flow characteristics, the inline RR cuts label usage, enabling cost-sensitive hardware to function effectively as RRs. Once all prefixes in a flow are withdrawn, their allocated label is released, further optimizing label utilization. Extensible to VPNv4/VPNv6 and other address families such as EVPN and MVPN, this method substantially improves scalability and performance while easing hardware resource demands in modern VPN networks.

### FIELD OF THE DISCLOSURE

The present disclosure relates generally to networking and computing. More particularly, the present disclosure relates to systems and methods for optimized multiprotocol label switching (MPLS) label allocation for border gateway protocol (BGP) Layer 3 virtual private network (L3VPN) Route Reflectors.

### BACKGROUND OF THE DISCLOSURE

Inline Layer 3 Virtual Private Network (L3VPN) route reflectors (RRs) are specialized devices (i.e., routers, switches, or generally network elements) in a provider network that redistribute VPN routing information among provider edge (PE) routers. Unlike an “offline” route reflector—where the original PE router remains the next hop in forwarded routes—an inline RR actively becomes the next hop for reflected VPN prefixes. By inserting itself into the forwarding path, the inline RR must allocate and manage Multiprotocol Label Switching (MPLS) labels for each reflected route. This can impose substantial demands on its data-plane resources, because every VPN route reflected through the RR may require a unique label entry. As L3VPN deployments grow and the number of VPN routes increases, inline RRs can quickly face label-space exhaustion or performance constraints, especially if the route reflector hardware is cost-sensitive or resource-limited. Consequently, managing label allocation efficiently in inline RRs is a critical challenge for scalable L3VPN designs.

### BACKGROUND OF THE DISCLOSURE

The present disclosure describes systems and methods for improving MPLS label allocation on Border Gateway Protocol (BGP) route reflectors (RRs) in large-scale VPN deployments. Particularly, it focuses on inline Layer 3 VPN (L3VPN) RRs, which must actively allocate labels for each reflected VPN prefix. Traditional per-prefix labeling schemes can quickly deplete the limited hardware resources (e.g., label space, FTN, ILM) of cost-sensitive or lower-end devices, thus preventing such devices from serving as inline RRs. In response, this disclosure proposes a per-flow label allocation mode. Here, a single MPLS label is assigned (which can also be referred to as associated or allocated) to a group of prefixes sharing the same “flow” attributes (e.g., out label, next-hop address, backup label, backup next hop), significantly reducing the total number of labels needed. When an inline RR receives a prefix with a new combination of flow attributes, it allocates one label for that flow; any subsequent prefixes matching the same attributes reuse the existing label. Once all prefixes associated with a flow are withdrawn, the label is freed. This innovation substantially lowers the label demand on inline RRs, enabling them to operate efficiently in large networks and on a wider range of hardware platforms. Additionally, the disclosed approach extends beyond VPNv4/VPNv6 to other VPN address families, such as EVPN and MVPN, delivering a scalable and flexible solution for modern network infrastructures.

In various embodiments, the present disclosure contemplates a method with steps, an inline router reflector configured to implement the steps, and a non-transitory computer-readable medium storing instructions that, when executed, cause circuitry to perform the steps. The steps include receiving a first route advertisement that includes a prefix and a set of flow attributes; determining whether a stored flow entry corresponding to the set of flow attributes exists; if, based on the determining, the stored flow entry does not exist, creating a flow entry and associating a MPLS label with the flow entry, and reflecting an updated route advertisement that includes the MPLS label associated with the flow entry; and if, based on the determining, the stored flow entry exists, associating the prefix with the stored flow entry.

The set of flow attributes can include an out label, an out next hop address, a backup out label, and a backup next hop address. The steps can further include detecting a failover event in which a primary path associated with the out label or out next hop address becomes unavailable; and continuing to use the MPLS label while switching to the backup out label and backup next hop address, thereby avoiding additional label allocation. The set of flow attributes can further include at least one additional attribute including one or more of a route distinguisher (RD), a route target (RT), a virtual routing and forwarding (VRF) identifier, a service policy identifier, or a load-balancing parameter. The steps can further include storing an association between the set of flow attributes and the MPLS label allocated to the flow entry.

The allocating the MPLS label for the flow entry can include requesting, from a label manager within the inline route reflector, a label identifier from a label pool; and installing, in a data-plane structure, a mapping between the allocated label identifier and a forwarding action based on the flow attributes. The steps can further include receiving a second route advertisement that includes a second prefix and the set of flow attributes from the first route advertisement; and if the stored flow entry exists for the set of flow attributes, associating the second prefix with the MPLS label already allocated to that flow entry. The steps can further include withdrawing one or more prefixes associated with the flow entry; determining that no remaining prefixes are associated with the flow entry; and releasing the MPLS label allocated to the flow entry in response to the determining that no remaining prefixes are associated with the flow entry.

The reflecting the updated route advertisement can include modifying a next-hop attribute in the route advertisement to specify the inline route reflector as a next hop; and transmitting the updated route advertisement to at least one other provider edge router via a Border Gateway Protocol (BGP) session. The steps can further include establishing, by the inline route reflector, a VPNv4 or VPNv6 Border Gateway Protocol (BGP) session with a provider edge (PE) router to receive the first route advertisement; and parsing the route advertisement to extract the prefix and the set of flow attributes. The reflecting the updated route advertisement can include embedding the MPLS label in a BGP update message; and sending the BGP update message to a downstream router for forwarding the prefix. The steps are applied in at least one environment including one of a Layer 3 virtual private network (L3VPN) environment, an Ethernet VPN (EVPN) environment, or a Multicast VPN (MVPN) environment, thereby extending a per-flow MPLS label allocation scheme to various VPN address families.

### BRIEF DESCRIPTION OF THE DRAWINGS

The present disclosure is illustrated and described with reference to the accompanying drawings. Unless otherwise specified, the drawings are not necessarily drawn to scale, and certain features or components may be enlarged, exaggerated, or omitted for clarity. Like reference numerals are used throughout to denote like components or steps, as appropriate.

FIG. 1 illustrates an example network including a VRF1, a VPN cloud, and an inline RR, illustrating conventional per-prefix label allocation at the RR.

FIG. 2 illustrates the example network including the VRF1, the VPN cloud, and the inline RR, illustrating per-flow label allocation at the RR according to the present disclosure.

FIG. 3 illustrates a flowchart of a process, performed by an inline route reflector, for allocating multiprotocol label switching (MPLS) labels.

FIG. 4 illustrates a block diagram of a router.

### DETAILED DESCRIPTION OF THE DISCLOSURE

Inline L3VPN route reflectors (RRs) play a pivotal role in distributing VPNv4 or VPNv6 routes across a provider network. “VPNv4” and “VPNv6” are shorthand notations for VPN-IPv4 (Internet Protocol version 4) and VPN-IPv6 (Internet Protocol version 6), respectively. These refer to specialized BGP address families used in Multiprotocol BGP (MP-BGP) for Layer 3 VPNs, where IPv4 or IPv6 prefixes are extended with additional attributes (e.g., route distinguishers (RD) and route targets (RT)) to create isolated routing domains across a shared provider network. Inline L3VPNs employ a combination of BGP and MPLS to securely transport customer routes (VPNv4 or VPNv6) across this shared backbone. In this setup, the provider edge (PE) routers connect to customer edge (CE) routers and maintain per-virtual routing and forwarding (VRF) instances, each carrying unique RDs and RTs.

An “inline” RR sits within the forwarding path, receiving VPNv4/VPNv6 routes from one PE and re-advertising them to other PEs while replacing the next hop to point to itself. By acting as the labeled next hop for traffic, the inline RR enforces accurate forwarding decisions and label imposition as packets traverse the provider network. Although this approach enables straightforward distribution of customer routes across the core, it also requires the inline RR to allocate and manage a label for each reflected prefix, which can rapidly consume hardware resources in larger deployments.

Unlike PE devices—where label allocation can be configured on a per-prefix or per-VRF basis—inline RRs are currently constrained to allocate a separate MPLS label for every VPN prefix they reflect. In large-scale deployments with thousands of VPN routes, this per-prefix labeling quickly depletes the route reflector’s MPLS label pool. Each label also consumes corresponding hardware resources, such as Forwarding Table (FTN) and Incoming Label Map (ILM) entries, which can be exhausted on platforms with limited capacity. As a result, lower-cost or otherwise hardware-limited devices cannot serve as inline VPN route reflectors because their label resource requirements would exceed their data-plane capabilities.

On a PE router handling L3VPN traffic, MPLS label allocation can operate under different modes depending on the network’s scalability and performance needs. In a per-prefix mode, each VPN route is assigned its own label, enabling direct forwarding to connected CE devices but requiring a large number of labels. In a per-VRF mode, a single label is assigned to all local routes within the same VRF. This approach reduces overall label usage at the PE but requires an additional IP lookup in the VRF forwarding table when forwarding traffic. While these modes offer flexibility on PE devices, they are not directly applicable to inline RRs, which remain bound to per-prefix label allocations.

A VRF is a separate routing instance on a router that allows multiple logical IP networks to coexist on the same physical hardware. Each VRF maintains its own routing table and forwarding rules, effectively isolating traffic so that packets in one VRF do not intermingle with those in another. When assigning labels in an MPLS-based Layer 3 VPN environment, two commonly used allocation modes are the per-prefix mode and the per-VRF mode.

In per-prefix mode, each individual VPN route (or prefix) is given a unique MPLS label. This allows direct forwarding decisions—once a packet arrives with a specific label, the router immediately knows which route it belongs to. However, this approach can require a very large number of labels, particularly in extensive networks containing thousands of routes. In per-VRF mode, a single MPLS label is assigned to all routes within the same VRF. When a packet arrives with that label, the router still must perform an IP lookup in the corresponding VRF’s routing table to determine the exact next hop for the final destination. Although this necessitates an additional lookup per packet, it greatly reduces the total number of labels because all prefixes in a VRF share one label instead of having a label per prefix.

Because inline RRs must assign a unique label for each prefix in the routes they reflect, their label pool and associated hardware entries (ILM and FTN) are consumed at an alarming rate. This issue becomes particularly acute in modern networks that carry large routing tables or support numerous VRFs. Consequently, operators who wish to deploy smaller or more cost-effective routers as inline RRs discover these devices cannot manage the sheer volume of required labels, rendering them unsuitable for VPN RR use cases. Overcoming this inefficiency in inline RRs is therefore important for improving L3VPN scalability and enabling a broader range of hardware platforms to function effectively as route reflectors.

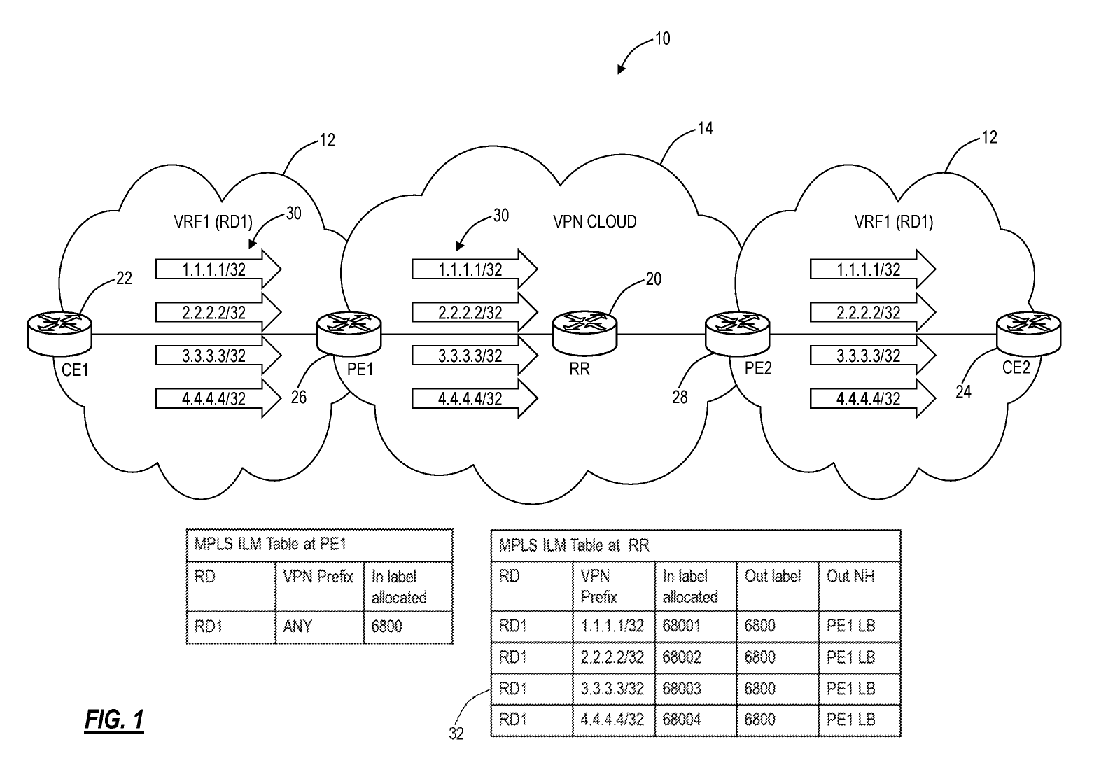

FIG. 1 illustrates an example network 10 including a VRF1 12, a VPN cloud 14, and an inline RR 20, illustrating conventional per-prefix label allocation at the RR 20. Within VRF1 12, there are two customer edge (CE) routers—CE1 22 and CE2 24—that connect to the provider’s network (i.e., the VPN cloud 14) via two provider edge (PE) routers—PE1 26 and PE2 28. The CE routers CE1 22 and CE2 24 belong to the customer’s network and typically run standard IP routing protocols, exchanging routing information with their respective PE routers PE1 26 and PE2 28. Each PE router PE1 26 and PE2 28 resides at the boundary of the provider’s backbone network and hosts one or more virtual routing and forwarding (VRF) instances to segregate customer traffic. The PE routers PE1 26 and PE2 28 run BGP sessions to distribute VPN routes and attach MPLS labels as needed to forward traffic securely through the VPN cloud 14.

The RR 20 in this figure is a specialized BGP component that redistributes routing information within the provider network. Instead of maintaining a full BGP mesh between all routers, the RR 20 collects routes from its clients (e.g., PE1 26, PE2 28) and reflects them to other clients. When configured as an inline RR, it can impose its own MPLS labels and function as the forwarding next hop for VPN routes. In the example shown, the VRF1 12 represents various customer locations, all interconnected by the VPN cloud 14 through the inline RR 20.

In FIG. 1, the PE routers PE1 26 and PE2 28 establish VPNv4 neighbor relationships with the RR 20. They also have IPv4 unicast neighbor relationships with CE1 22 and CE2 24, respectively, within VRF1 12. CE1 22 advertises four example prefixes 30—1.1.1.1/32, 2.2.2.2/32, 3.3.3.3/32, and 4.4.4.4/32—to PE1 26. The PE1 26 router then advertises these prefixes 30 as VPNv4 prefixes to the RR 20. Under a per-VRF MPLS label allocation scheme, PE1 26 allocates a single MPLS label (label 68000) for all four prefixes 30 and advertises that label to the RR 20.

Because the inline RR 20 allocates labels on a per-prefix basis for reflected routes, it assigns a unique MPLS label for each distinct VPNv4 prefix and route distinguisher (RD). Accordingly, the RR 20 allocates four labels—68001 for 1.1.1.1/32, 68002 for 2.2.2.2/32, 68003 for 3.3.3.3/32, and 68004 for 4.4.4.4/32—and reflects these prefixes to PE2 28 with the respective MPLS in-labels (see table 32).

In large-scale VPNv4/VPNv6 deployments, the inline RR 20 can rapidly exhaust its MPLS label pool and hardware resources (e.g., Forwarding Table (FTN) and Incoming Label Map (ILM)) while handling these prefixes 30. The following sections describe how this problem can be addressed to achieve better scalability and performance for inline route reflectors.

### Per-Flow MPLS Label Allocation

A new per-flow MPLS label allocation mode is introduced for reflected VPNv4/V6 routes on inline route reflectors (RRs), i.e., the RR 20. Again, traditionally, inline RRs assign a unique MPLS label for each VPN prefix they reflect, which rapidly consumes label and hardware resources in large networks. Under this new approach, all prefixes that share the same combination of four key attributes—(1) Out Label, (2) Out Next Hop (IPv4/IPv6), (3) Backup Out Label, and (4) Backup Next Hop (IPv4/IPv6)—are grouped into a single flow and assigned a single MPLS label. Specifically, when an RR receives its first prefix for a unique set of these attributes, it allocates a fresh label; when all prefixes associated with that flow are eventually withdrawn, the label is released. By grouping multiple prefixes under one label, RRs can significantly reduce the total number of labels required. This more efficient allocation mechanism not only saves resources in the data plane but also provides better scalability and performance across large Layer 3 VPN deployments. Additionally, although described in the context of VPNv4 and VPNv6 routes, this methodology extends seamlessly to other VPN address families such as Ethernet VPN (EVPN) and Multicast VPN (MVPN).

This new mode—referred to as per-flow label allocation—shifts away from the per-prefix paradigm. When the RR detects a new flow (a unique combination of the four attributes listed above), it assigns one MPLS label for all VPNv4 or VPNv6 prefixes that match those attributes. The label allocation occurs upon receipt of the first prefix that corresponds to the new flow. As subsequent prefixes arrive with the same set of attributes, they are simply added to the existing flow, thereby not requiring additional labels. Once all prefixes for that flow are withdrawn or become inactive, the label is freed and returned to the RR’s available pool. By adopting this per-flow approach, inline RRs achieve better utilization of MPLS label pools and avoid the high label churn and resource depletion inherent in per-prefix allocations. Consequently, operators can deploy inline RRs on a broader range of hardware platforms, including those with more modest resource capabilities, all while maintaining robust scalability in extensive VPN environments.

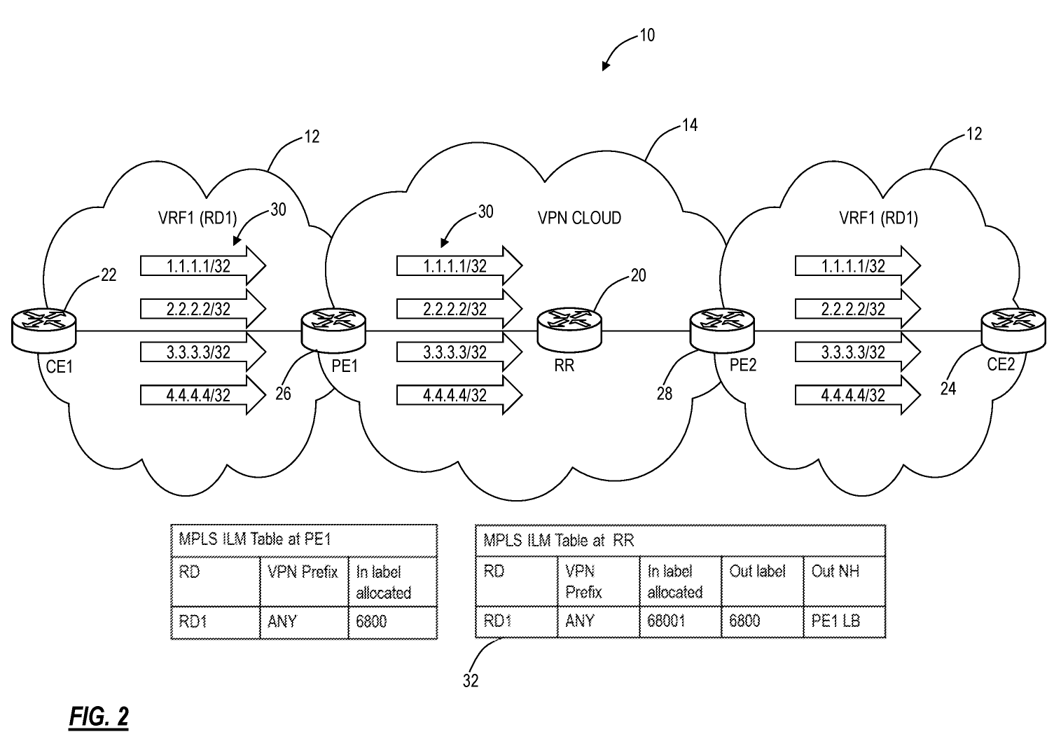

FIG. 2 illustrates the example network 10 including the VRF1 12, the VPN cloud 14, and the inline RR 20, illustrating per-flow label allocation at the RR 20 according to the present disclosure. Of note, FIG. 2 has the same network layout and illustrates the same example as in FIG. 1 except with the RR 20 configured with per-flow label allocation. Again, the PE routers PE1 26 and PE2 28 have VPNV4 neighborship with the RR 20. The PE routers PE1 26 and PE2 28 have IPv4 unicast neighborship with the CE routers CE1 22 and CE2 24, respectively, in the VRF1 12. The CE router CE1 22 advertises the four prefixes 30 (1.1.1.1/32, 2.2.2.2/32, 3.3.3.3/32 and 4.4.4.4/32) to the PE router PE1 26. The PE router PE1 26 advertises these prefixes as VPNv4 prefixes to the RR 20. Again, the PE router PE1 26 has per-VRF MPLS label allocation configured such that the PE router PE1 will allocate MPLS Label 68000 for all 4 prefixes 30 and advertise the same to the RR 20.

With the use of this new mode of MPLS label allocation on the RR 20, i.e., the per-flow label allocation, the RR 20 will allocate only one MPLS label, e.g., 68001 for all four VPN prefixes 30 (1.1.1.1/32, 2.2.2.2/32, 3.3.3.3/32 and 4.4.4.4/32) which saves the MPLS label pool space at the RR 20. For example, the per-flow label allocation at the RR 20 can be used when there is per-VRF label allocation at the PE router PE1 26. This solution can also be used in MPLS label allocation on Inline Route Reflectors of other VPN address families such as Ethernet VPN (EVPN), multicast VPN (MVPN), etc.

### Flow Attributes

Per-flow label allocation hinges on the concept that any group of prefixes sharing the same forwarding characteristics can be treated as a single “flow.” In various embodiments of the proposed scheme, these forwarding characteristics are captured by four specific attributes:
(1) Out Label: This is the MPLS label advertised by the upstream router (e.g., a PE router) for traffic heading toward a particular VPN route. Whenever the inline RR 20 receives prefixes tagged with the same out label, it can logically group them as part of the same flow—provided the other attributes also match.
(2) Out Next Hop (IPv4/IPv6 Address): The next-hop IP address identifies where packets should be forwarded after leaving the inline RR 20. If multiple prefixes share the same out label and the same next-hop IP, they continue to fall under the same flow, because the RR 20 will forward them along the same path.
(3) Backup Out Label: This secondary label may be used when a primary path is unavailable or fails. By including a backup label in the flow definition, the RR 20 can handle path changes or reroutes without needing to allocate separate labels for failover scenarios—so long as the rest of the flow attributes remain unchanged.
(4) Backup Next Hop (IPv4/IPv6 Address): Corresponding to the backup out label, the backup next hop is the IP address used when forwarding switches from the primary path to an alternate path. If both out label/next hop and backup label/next hop match for a set of prefixes, the RR 20 treats them as a single flow even during backup path operation.

A “flow” is essentially a combination of forwarding decisions that apply uniformly to a group of prefixes. If two or more prefixes share the same out label, out next hop, backup out label, and backup next hop, they can all be mapped to the same flow—and therefore share a single RR-allocated label. Once that flow is established, the inline RR 20 only needs to perform additional label allocations if a prefix arrives with a new set of attribute values. Conversely, when all prefixes belonging to a flow are withdrawn, the associated flow label is freed.

This approach significantly reduces label consumption because the RR 20 is no longer required to allocate a separate label per prefix. Instead, it tracks labels on a “per flow” basis, where each flow represents a unique set of forwarding behaviors.

Although the four attributes above work effectively in many deployments, network operators can tailor the definition of a “flow” to suit different requirements or topologies. For instance, one might include additional or alternative attributes, such as:
(1) Route Distinguisher (RD) or Route Target (RT): Used commonly in L3VPN contexts, including the RD or RT in the flow definition could help further segregate traffic belonging to different VPNs—even if they share the same out label or next-hop IP.
(2) VRF Identifier: The inline RR 20 might group prefixes by VRF, ensuring that all prefixes in the same VRF are labeled identically, regardless of slight variations in next hops or labels (useful in certain traffic engineering scenarios).
(3) Service Policies or Access Control Attributes: In more advanced service-chaining architectures, the flow definition could incorporate policy identifiers (e.g., quality-of-service (QoS) levels or access control lists) to ensure that all routes requiring the same policy also share a single label.
(4) Load-Balancing or equal cost multi-path (ECMP) Attributes: If multiple equal-cost paths exist, the RR 20 might define a flow to account for distinct sets of equal-cost paths. This could allow more granular control over which prefixes share labels, possibly aligning with traffic engineering or load-balancing requirements.

Additionally or alternatively, attributes can be defined and used which are equivalent to or which express one, two or more of the above-mentioned attributes, or similar attributes, or which otherwise adequately capture the required forwarding characteristics.

In all cases, the core principle remains the same: grouping prefixes into fewer flows based on common forwarding attributes helps reduce the per-prefix overhead at the inline RR 20. By tailoring which attributes form the basis of a flow, operators can balance simplicity, hardware constraints, and the granularity of routing policy needed in their networks.

### Inline RR Constraints and Motivation

Many lower-end or cost-sensitive RRs are constrained by limited memory and hardware label space, making them ill-suited for large-scale deployments. In networks where each VPN prefix requires its own MPLS label, the resource demands on such RRs can be overwhelming. Each label consumes additional data-plane resources—such as ILM and FTN entries—further straining the platform. While PE routers often employ a per-VRF label allocation scheme to reduce label usage, inline RRs remain stuck in a per-prefix allocation model. Unlike offline RRs, which can simply pass along the original PE’s next hop, inline RRs act as the next hop themselves, thus requiring new labels for every reflected VPN prefix. Consequently, if a PE advertises thousands of prefixes—even under a per-VRF label mode on the PE—an inline RR without an enhanced allocation mechanism would still need to assign thousands of new labels. This makes it difficult for service providers or enterprises to deploy cheaper or resource-limited routers as inline RRs.

To address these constraints, the new per-flow MPLS label allocation mode is proposed for VPNv4/V6 inline route reflectors. Instead of assigning a separate label for each VPN prefix, the RR groups prefixes that share the same next hop and label information into a single “flow.” Specifically, in illustrative embodiments, a flow is identified by four key attributes: Out Label, Out Next Hop IP Address, Backup Out Label, and Backup Out Next Hop IP Address. If multiple prefixes arriving from the same PE share these attributes, the RR assigns a single MPLS label to the entire set, significantly reducing total label consumption. This approach primarily shifts the complexity to control-plane lookups, alleviating pressure on the RR’s data plane.

Under this new mode, each flow is recognized when the first VPNv4/V6 prefix with a distinct combination of the four attributes arrives at the RR for reflection. At that point, the RR allocates a new MPLS label for the flow. As additional prefixes that match the same flow attributes appear, they are associated with the existing label rather than requiring separate ones. When all prefixes corresponding to a particular flow are withdrawn, the RR frees the label, returning it to the available pool. By consolidating prefixes under one label, inline RRs can achieve far better resource efficiency. This enhanced scheme keeps the label count manageable, significantly improves scalability, and permits lower-end devices to function more effectively as inline RRs.

### Optimization and Potential Benefits

Adopting the new per-flow MPLS label allocation mode leads to better utilization of an inline RR’s MPLS label pool, thereby enhancing both scalability and overall performance. By grouping all prefixes that share the same set of flow attributes under a single label, the RR minimizes the total number of labels in use, helping it manage a larger volume of VPNv4/V6 routes without exhausting its available label resources.

Improved Scalability—By assigning a single label to all prefixes belonging to the same flow, an RR drastically reduces the number of labels it needs to handle. This approach prevents rapid label exhaustion and allows a route reflector to support a significantly higher number of VPNv4/V6 prefixes, even in large-scale networks.

Optimized Hardware Resource Usage—Fewer labels translate into fewer FTN and ILM entries. As a result, the RR consumes less memory and processing capacity, making it better suited for platforms with limited hardware resources.

Better Performance and Efficiency—Reducing the total number of labels also streamlines the RR’s forwarding operations. Since there are fewer label lookups to perform, packet handling becomes more efficient. In turn, this lightens the control-plane load and speeds up convergence in fast-changing network environments.

Cost-Effectiveness—Because per-flow label allocation lowers hardware and memory requirements, operators can deploy RRs on smaller or less expensive devices. This flexibility can reduce both capital expenditures and operational expenses, making the overall solution more cost-efficient.

Applicability to Multiple VPN Families—Although the new allocation mode is primarily discussed in the context of VPNv4/V6 address families, the same per-flow concept can be extended to other VPN technologies like EVPN and MVPN. This wider applicability further boosts scalability and performance across diverse Layer 3 VPN deployments.

Of note, while the present disclosure states “optimized MPLS label allocation,” those skilled in the art will appreciate optimized is meant to convey some improvement from the conventional approach, i.e., better utilization of an inline RR’s MPLS label pool. That is, optimized is not meant to mean the absolute best or perfect approach, but rather an improved approach.

### Process

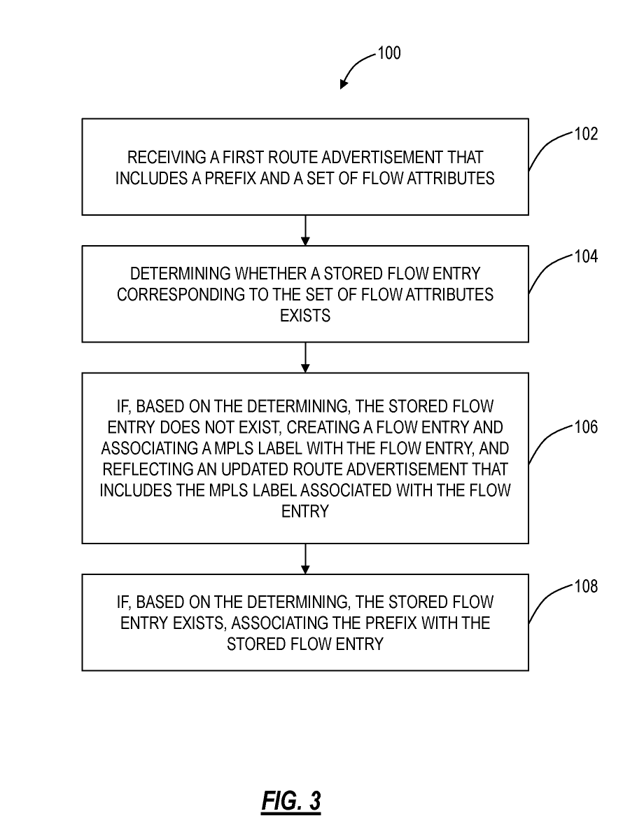

FIG. 3 illustrates a flowchart of a process 100, performed by an inline route reflector, for allocating multiprotocol label switching (MPLS) labels. The process 100 contemplates implementation as a method with steps, via circuitry configured to implement the steps, and as a non-transitory computer-readable medium storing instructions that, when executed, cause circuitry to implement the steps.

The steps include receiving a first route advertisement that includes a prefix and a set of flow attributes (step 102). The steps include determining whether a stored flow entry corresponding to the set of flow attributes exists (e.g. within an area of computer memory for the inline route reflector) (step 104). In such a case the determining may involve checking such an area of computer memory. The steps include, if (based on the determining) no stored flow entry exists, creating a flow entry and associating a MPLS label with the flow entry. The steps include, if, based on the determining, the stored flow entry does not exist, creating a flow entry and associating a MPLS label with the flow entry, and reflecting an updated route advertisement that includes the MPLS label associated with the flow entry (step 106). The steps also include, if, based on the determining, the stored flow entry exists, associating the prefix with the stored flow entry (step 108).

The steps include reflecting an updated route advertisement that includes the MPLS label associated with the flow entry (step 108). For clarity, the MPLS label included in the reflection may be newly associated with the flow entry, due to the above-mentioned creation and association step. In the event that the stored flow entry already exists, the MPLS label included in the reflection may be associated with the flow entry via a previous iteration of the process, namely the iteration in which the flow entry was created and associated with the MPLS label.

In an embodiment, the set of flow attributes can include an out label, an out next hop address, a backup out label, and a backup next hop address. The steps can further include detecting a failover event in which a primary path associated with the out label or out next hop address becomes unavailable; and continuing to use the MPLS label while switching to the backup out label and backup next hop address, thereby avoiding additional label allocation. The set of flow attributes can further include at least one additional attribute include one or more of a route distinguisher (RD), a route target (RT), a virtual routing and forwarding (VRF) identifier, a service policy identifier, or a load-balancing parameter.

The steps can further include storing an association between the set of flow attributes and the MPLS label allocated to the flow entry. Allocating the MPLS label for the flow entry can include requesting, from a label manager within the inline route reflector, a label identifier from a label pool; and installing, in a data-plane structure, a mapping between the allocated label identifier and a forwarding action based on the flow attributes. The steps can further include receiving a second route advertisement that includes a second prefix and the set of flow attributes from the first route advertisement; and if the stored flow entry exists for the set of flow attributes, associating the second prefix with the MPLS label already allocated to that flow entry.

The steps can further include withdrawing one or more prefixes associated with the flow entry; determining that no remaining prefixes are associated with the flow entry; and releasing the MPLS label allocated to the flow entry in response to the determining. Reflecting the updated route advertisement can include modifying a next-hop attribute in the route advertisement to specify the inline route reflector as the next hop; and transmitting the updated route advertisement to at least one other provider edge router via a Border Gateway Protocol (BGP) session.

The steps can further include establishing, by the inline route reflector, a VPNv4 or VPNv6 Border Gateway Protocol (BGP) session with a provider edge (PE) router to receive the first route advertisement; and parsing the route advertisement to extract the prefix and the set of flow attributes. Reflecting the updated route advertisement can include embedding the MPLS label in a BGP update message; and sending the BGP update message to a downstream router for forwarding the prefix. The method can be applied in at least one environment including one of a Layer 3 virtual private network (L3VPN) environment, an Ethernet VPN (EVPN) environment, or a Multicast VPN (MVPN) environment, thereby extending a per-flow MPLS label allocation scheme to various VPN address families.

### Router

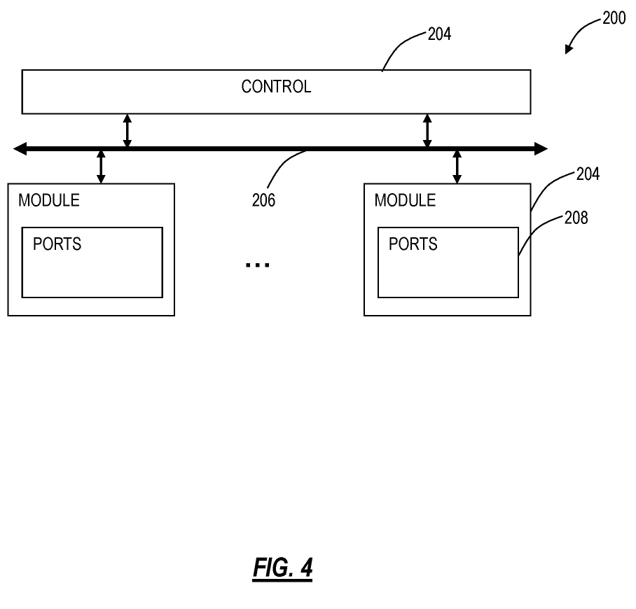

FIG. 4 illustrates a block diagram of a router 200, depicted in a simplified functional format. It is important to note that a more practical design of this router would likely include additional components and processing logic to accommodate standard operating features, which are not detailed here. The router 200 may represent any network element operable in a network using optical and packet protocols, and includes various interconnected modules, such as modules 204, 204, via an interface 206, such as a backplane, midplane, cabling, etc. These modules, also known as blades or line cards, are typically mounted on the chassis. Each module 204, 206 can house numerous electronic or optical devices on a circuit board, complete with various interconnects, including interfaces to the chassis itself.

Specifically, the diagram illustrates two types of modules: line modules 200, which feature multiple ports 208 for external connections, and a control module 204. The line modules 202 facilitate data traffic switching between ports 208 via a switching fabric, which can be integrated across the modules 202, potentially centralized in a separate unit or module (not shown), as well as a combination. This switching fabric includes hardware, software, and firmware that routes data between the ports 208. The control module 204 is equipped with processing circuity, memory, software, and a network interface to manage operations such as configuration and monitoring of the router 200. It may also communicate with external network management systems or databases that handle provisioning and operational data.

Lastly, while FIG. 4 provides a basic view, those skilled in the art will understand that the router 200 could include additional components or be configured differently, such as in a distributed arrangement or as an integrated, rack-mounted unit (often referred to as a "pizza-box" configuration). This depiction in FIG. 4 is intended to convey functional aspects, with actual hardware implementations varying widely. In an embodiment, the router 200 can be any of the network elements described herein, including the CE routers CE1 22 and CE2 24, the PE routers PE1 26 and PE2 28, and the inline RR 20. Also, in another embodiment, the router 200 can implement the process 100 and the like.

Further, those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps—even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement—whether collectively, separately, or in subsets—thereby broadening the range of potential embodiments.

What is claimed is:

1. A method, performed by an inline route reflector, for allocating multiprotocol label switching (MPLS) labels, the method comprising steps of:
receiving a first route advertisement that includes a prefix and a set of flow attributes;
determining whether a stored flow entry corresponding to the set of flow attributes exists;
if, based on the determining, the stored flow entry does not exist, creating a flow entry and associating a MPLS label with the flow entry, and reflecting an updated route advertisement that includes the MPLS label associated with the flow entry; and
if, based on the determining, the stored flow entry exists, associating the prefix with the stored flow entry.

2. The method of claim 1, wherein the set of flow attributes includes an out label, an out next hop address, a backup out label, and a backup next hop address.

3. The method of claim 2, wherein the steps further include
detecting a failover event in which a primary path associated with the out label or out next hop address becomes unavailable; and
continuing to use the MPLS label while switching to the backup out label and backup next hop address, thereby avoiding additional label allocation.

4. The method of claim 2, wherein the set of flow attributes further includes at least one additional attribute including one or more of
a route distinguisher (RD),
a route target (RT),
a virtual routing and forwarding (VRF) identifier,
a service policy identifier, or
a load-balancing parameter.

5. The method of claim 1, wherein the steps further include
storing an association between the set of flow attributes and the MPLS label allocated to the flow entry.

6. The method of claim 5, wherein the allocating the MPLS label for the flow entry includes
requesting, from a label manager within the inline route reflector, a label identifier from a label pool; and
installing, in a data-plane structure, a mapping between the allocated label identifier and a forwarding action based on the flow attributes.

7. The method of claim 1, wherein the steps further include
receiving a second route advertisement that includes a second prefix and the set of flow attributes from the first route advertisement; and
if the stored flow entry exists for the set of flow attributes, associating the second prefix with the MPLS label already allocated to that flow entry.

8. The method of claim 1, wherein the steps further include
withdrawing one or more prefixes associated with the flow entry;
determining that no remaining prefixes are associated with the flow entry; and
releasing the MPLS label allocated to the flow entry in response to the determining that no remaining prefixes are associated with the flow entry.

9. The method of claim 1, wherein the reflecting the updated route advertisement includes
modifying a next-hop attribute in the route advertisement to specify the inline route reflector as a next hop; and
transmitting the updated route advertisement to at least one other provider edge router via a Border Gateway Protocol (BGP) session.

10. The method of claim 1, wherein the steps further include
establishing, by the inline route reflector, a VPNv4 or VPNv6 Border Gateway Protocol (BGP) session with a provider edge (PE) router to receive the first route advertisement; and
parsing the route advertisement to extract the prefix and the set of flow attributes.

11. The method of claim 1, wherein the reflecting the updated route advertisement includes
embedding the MPLS label in a BGP update message; and
sending the BGP update message to a downstream router for forwarding the prefix.

12. The method of claim 1, wherein the method is applied in at least one environment including one of
a Layer 3 virtual private network (L3VPN) environment,
an Ethernet VPN (EVPN) environment, or
a Multicast VPN (MVPN) environment, thereby extending a per-flow MPLS label allocation scheme to various VPN address families.

13. An inline route reflector, configured to allocate multiprotocol label switching (MPLS) labels, the inline route reflector comprising:
a plurality of ports; and circuitry configured to
receive a first route advertisement that includes a prefix and a set of flow attributes;
determine whether a stored flow entry corresponding to the set of flow attributes exists;
if the stored flow entry does not exist, creating a flow entry and associating a MPLS label with the flow entry, and reflecting an updated route advertisement that includes the MPLS label associated with the flow entry; and
if the stored flow entry exists, associating the prefix with the stored flow entry.

14. The inline route reflector of claim 13, wherein the set of flow attributes includes an out label, an out next hop address, a backup out label, and a backup next hop address.

15. The inline route reflector of claim 13, wherein the circuitry is further configured to
store an association between the set of flow attributes and the MPLS label allocated to the flow entry.

16. The inline route reflector of claim 13, wherein the circuitry is further configured to
receive a second route advertisement that includes a second prefix and the set of flow attributes from the first route advertisement, and
if the stored flow entry exists for the set of flow attributes, associate the second prefix with the MPLS label already allocated to that flow entry.

17. The inline route reflector of claim 13, wherein the circuitry is further configured to
withdraw one or more prefixes associated with the flow entry,
determine that no remaining prefixes are associated with the flow entry, and
release the MPLS label allocated to the flow entry in response to there being no remaining prefixes.

18. The inline route reflector of claim 13, wherein the updated route advertisement is reflected by
modifying a next-hop attribute in the route advertisement to specify the inline route reflector as a next hop, and
transmitting the updated route advertisement to at least one other provider edge router via a Border Gateway Protocol (BGP) session.

19. A non-transitory computer-readable medium for allocating multiprotocol label switching (MPLS) labels, the non-transitory computer-readable medium storing instructions that, when executed, cause an inline route reflector to perform steps of:
receiving a first route advertisement that includes a prefix and a set of flow attributes;
determining whether a stored flow entry corresponding to the set of flow attributes exists;
if, based on the determining, the stored flow entry does not exist, creating a flow entry and associating a MPLS label with the flow entry, and reflecting an updated route advertisement that includes the MPLS label associated with the flow entry; and
if, based on the determining, the stored flow entry exists, associating the prefix with the stored flow entry.

20. The non-transitory computer-readable medium of claim 19, wherein the set of flow attributes includes an out label, an out next hop address, a backup out label, and a backup next hop address.
